(19) United States
(12) Patent Application Publication
(10) Pub. No.: US 2016/0066370 A1
(43) Pub. Date: Mar. 3, 2016

(54) Filter for lamp

(71) Applicant: WEI ZHAO, Allen, TX (US)

(72) Inventor: WEI ZHAO, Allen, TX (US)

(73) Assignees: Upright Lighting LLC, Allen, TX (US); XI'AN Upright Photoelectric Technology Co., Ltd, Xi'an (CN)

(21) Appl. No.: 14/473,515

(22) Filed: Aug. 29, 2014

(51) Int. Cl. H05B 33/08; H05B 37/02

(52) U.S. Cl. CPC H05B 33/0803; H05B 37/02; H05B 33/0896

(57) ABSTRACT

The invention is a lamp filter composed of reference, error amplifier, feedback and controlled component to remove ripple or noise from power supply to lamp.

### BACKGROUND

The following disclosure relates to electrical circuit for lamp.

A filter is used to remove the noise of the switching power supply for lamps. Convention filter typically includes a R-C filter composed of a resistor and a capacitor or an L-C filter composed of an inductor and a capacitor.

For a R-C filter, If you want to decrease the noise to 1/10000 of original magnitude, that is 20 log( 1/10000)=−80 dB, the noise frequency must be at least 10000 times of corner frequency of R-C filter. Only very high frequency noise can be removed.

For a L-C filter, If you want to decrease the noise to 1/10000 of original magnitude, that is 20 log( 1/10000)=−80 dB, the noise frequency must be at least 100 times of corner frequency of R-C filter. Only very high frequency noise can be removed.

### SUMMARY

The invention is a lamp filter composed of reference, error amplifier, feedback and controlled component to remove ripple or noise from power supply to lamp. This invention can remove low frequency, middle frequency and high frequency noise for lamps.

### DESCRIPTION OF DRAWINGS

FIG. 1 is the schematic of typical R-C filter between power supply and a lamp. (prior art).

FIG. 2 is the Bode Plot of the gain transfer function for a R-C filter.

FIG. 3 is the schematic of a typical L-C filter between power supply and lamp. (prior art).

FIG. 4 is the Bode Plot of gain transfer function for L-C filter.

FIG. 5 is the block diagram of the invention 100.

FIG. 6 is a schematic of the invention based on a linear regulator with a PNP bipolar junction transistor.

FIG. 7 is a schematic of the invention based on a linear regulator with a NPN bipolar junction transistor.

FIG. 8 is a schematic of a small signal equivalent circuit of FIG. 6 and FIG. 7.

FIG. 9 is a schematic of the invention based on a linear regulator with a P channel Field-Effect transistor (FED.

FIG. 10 is a schematic of the invention based on a linear regulator with a N channel Field-Effect transistor (FED.

FIG. 11 is a schematic of a small signal equivalent circuit of FIG. 9 and FIG. 10.

FIG. 12 is a schematic of a low drop out regulator integrated circuit used in the invention.

FIG. 13 is a block diagram of the invention with an input L-C filter and an output L-C filter.

FIG. 14 is a schematic of a low drop out regulator integrated circuit used in the invention with an input L-C filter and an output L-C filter.

FIG. 15 is a block diagram of the invention with an output L-C filter.

FIG. 16 is a schematic of a low drop out regulator integrated circuit used in the invention with an output L-C filter.

FIG. 17 is a block diagram of the invention with an input L-C filter.

FIG. 18 is a schematic of a low drop out regulator integrated circuit used in the invention with an input L-C filter.

### DETAILED DESCRIPTION

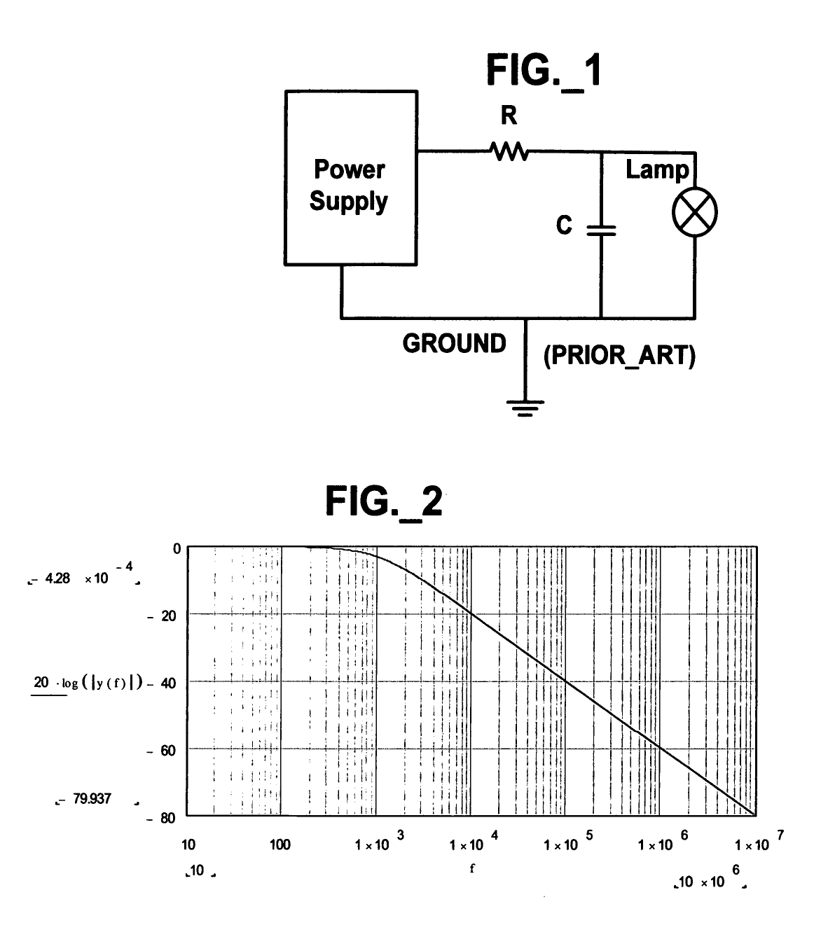

FIG. 1 is the schematic of a typical R-C filter between power supply and a lamp. (prior art).

FIG. 2 is the Bode Plot of gain transfer function for R-C filter. Corner frequency fc=1/(2π·R·C); Only noise with frequency above the corner frequency of R-C filter can be reduced. If you want to decrease the noise to 1/10000 of original magnitude, that is 20·log ( 1/10000)=−80 dB, the noise frequency must be at least 10000 times of corner frequency of R-C filter. On FIG. 2, corner frequency is 1000 Hz, the frequency above 1000·10000=10⁷, the noise can be reduced to 1/10000 of original magnitude.

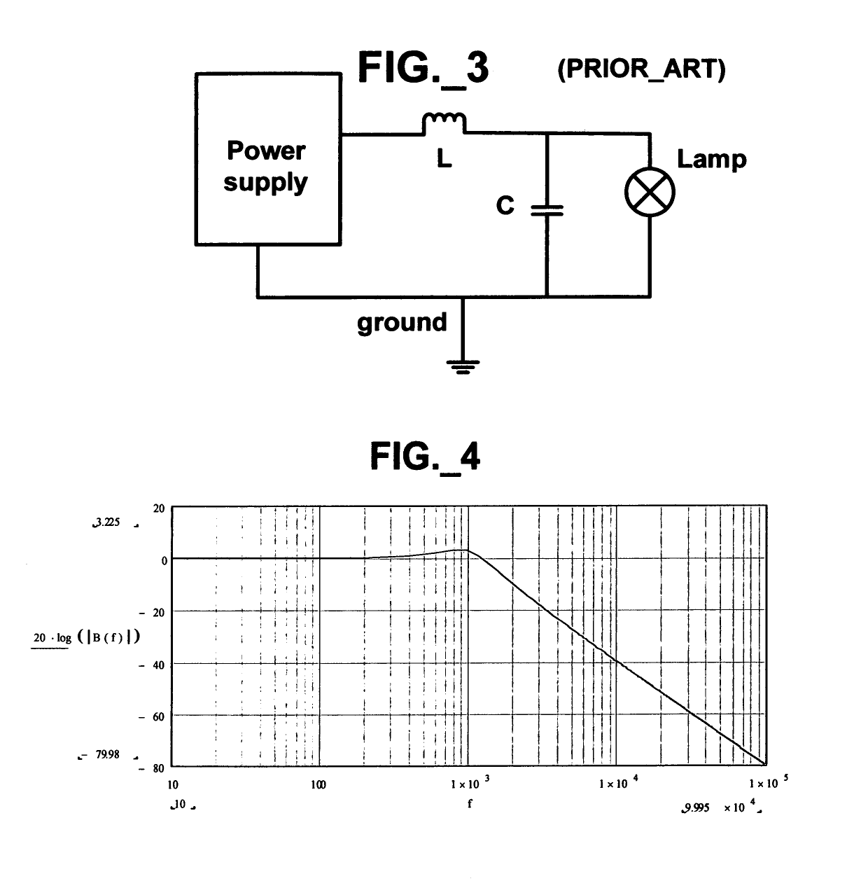

FIG. 3 is the schematic of a typical L-C filter between power supply and lamp (prior art). fc is the corner frequency.

FIG. 4 is the Bode Plot of gain transfer function for L-C filter.

Corner frequency is square the root of production of L and C.

$$fc := \frac{1}{2 \cdot π \cdot \sqrt{L \cdot C}}$$

Only noise with frequency above the corner frequency of L-C filter can be reduced. If you want to decrease the noise to 1/10000 of original magnitude, that is 20·log( 1/10000)=−80 dB, the noise frequency must be at least 100 times of corner frequency of L-C filter. On FIG. 4, corner frequency is 1000 Hz, the frequency above 1000*100=¹⁰⁵ the noise can be reduced to 1/10000 of original magnitude.

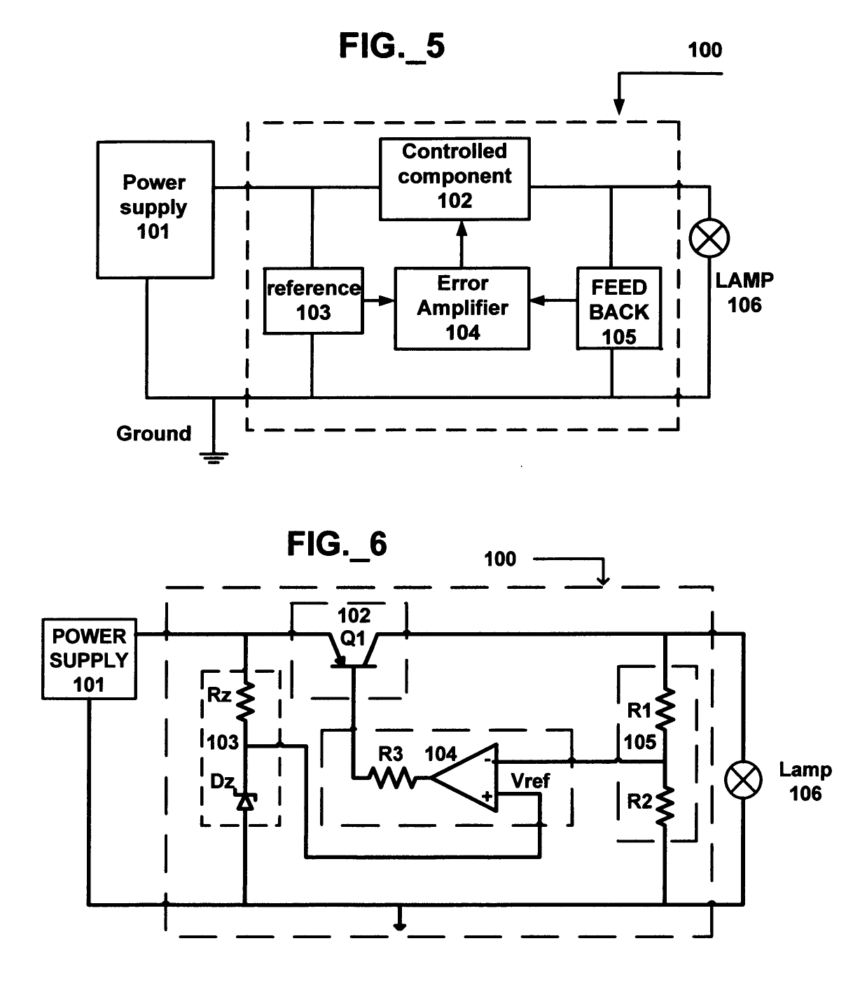

FIG. 5 is the block diagram of the invention 100.

Input voltage comes from power supply 101 and output voltage supplies current to lamp 106. Feedback 105 feeds back voltage signal and compares with reference 103 by Error Amplifier 104. The output of Error Amplifier 104 controls the controlled component 102 to regulate the output voltage at predetermined value.

FIG. 6 is a schematic of the invention based on a linear regulator with a PNP bipolar junction transistor.

Here, the controlled component 102 is a PNP bipolar junction transistor. Power supply 101 supplies current through the PNP bipolar junction transistor Q1 to lamp 106. Reference 103 is composed of a resistor Rz and a zener diode Dz. Voltage divider composed of resistors R1 and R2 works as the feedback 105. Feedback 105 feeds output voltage signal back to compare with reference voltage Vref through Error Amplifier 104. The output of Error Amplifier 104 supplies voltage to resistor R3 to control current through transistor Q1 from input power supply 101 to lamp 106 by controlling the current through the base of the PNP bipolar junction transistor Q1.

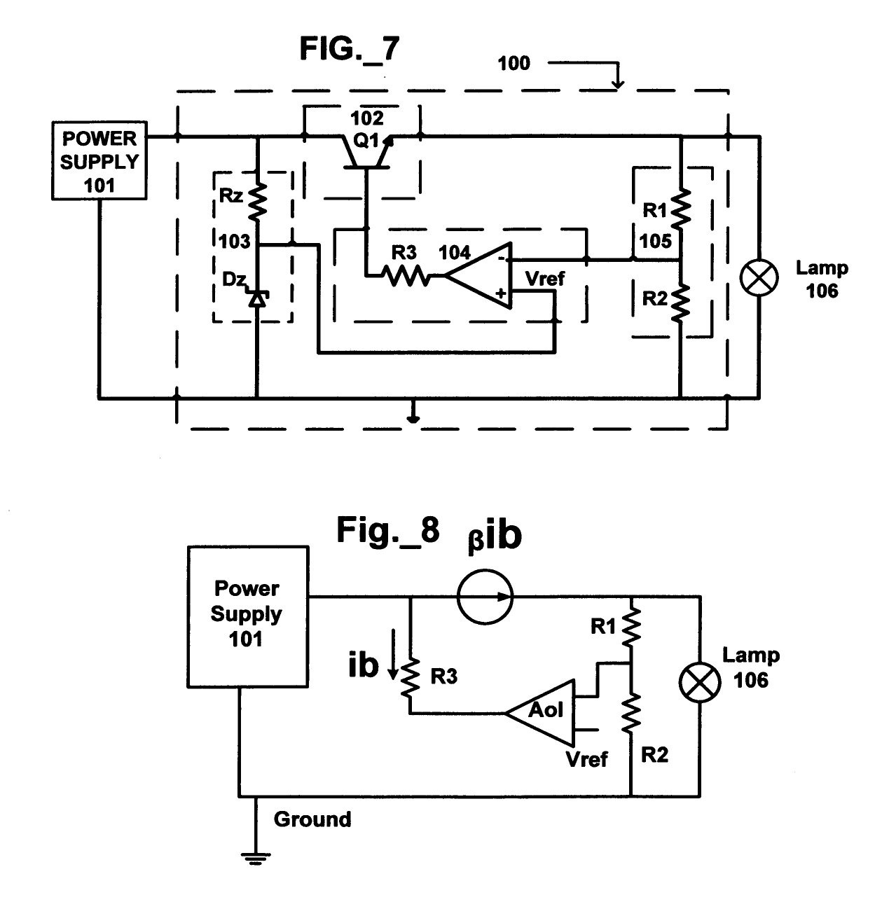

FIG. 7 is a schematic of the invention based on a linear regulator with a NPN bipolar junction transistor.

The only difference between FIG. 7 and FIG. 6 is FIG. 7 uses a NPN bipolar junction transistor as Q1 that is controlled component 102.

FIG. 8 is a schematic of a small signal equivalent circuit of FIG. 6 and FIG. 7.

Assume input voltage has small ripple Vin and lamp resistance is r.

Output voltage of Error Amplifier is Va, output voltage is Vo;

Open loop gain of the Error Amplifier IS Aol, β is the current gain of the transistor;

$$Va := Vo \cdot ( \frac{R 2}{R 1 + R 2} ) \cdot Aol$$

$$Vo := β \cdot ib \cdot r$$

$$ib := \frac{( Vin - Va )}{R 3}$$

From above equations, we get

$$Vo := \frac{Vin}{( \frac{R 2}{R 1 + R 2} ) \cdot Aol + \frac{R 3}{β \cdot r}}$$

$$R 2 \text{/} ( R 1 + R 2 ) = 0.1 , \\ Aol = 100000 , R 3 - 1 k , β = 100 , r = 30$$

So we get Vo=Vin/(100000+0.3), So if input has a ripple or noise Vin, output noise or ripple will be reduced to 1/100000. Input ripple typical value is 100 mv, so the ripple is reduced to 0.1V/100000= 1/1000000V. That is almost 0.

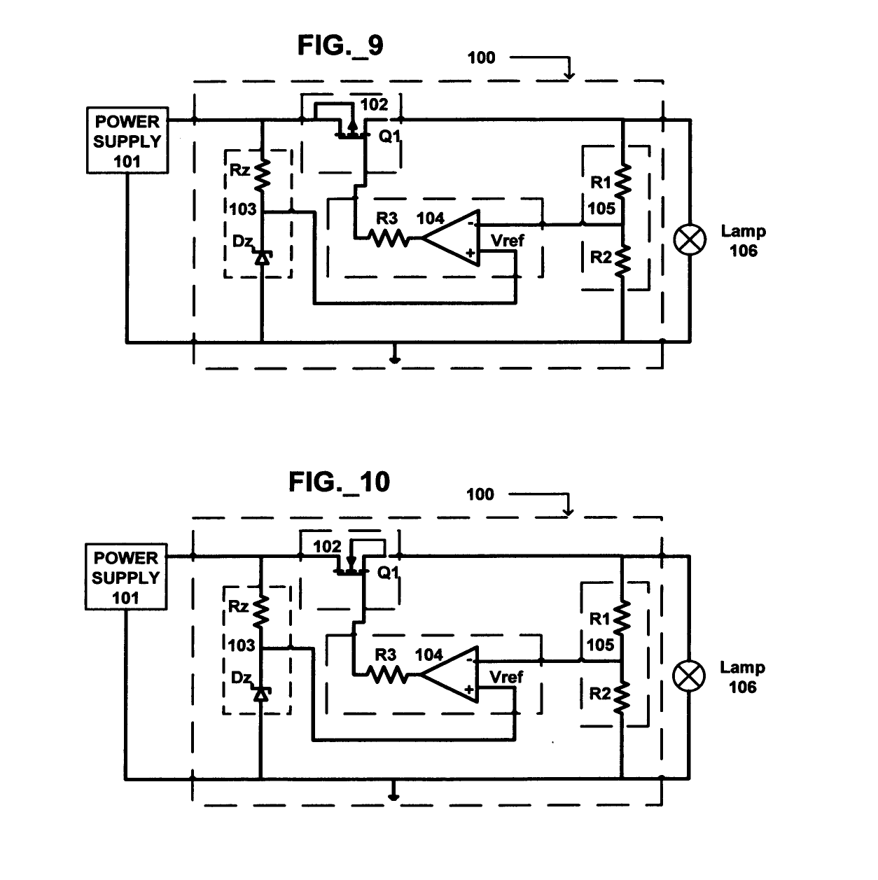

FIG. 9 is a schematic of the invention based on a P channel Field-Effect transistor (FET).
The only difference between FIG. 9 and FIG. 6 is FIG. 9 uses a linear regulator with a P Channel Field-Effect transistor (FET) as Q1.

FIG. 10 is a schematic of the invention based on a linear regulator with a N channel Field-Effect transistor.
The only difference between FIG. 10 and FIG. 6 is that Q1 is a N Channel Field-Effect transistor in FIG. 10.

FIG. 11 is a schematic of a small signal equivalent circuit of FIG. 9 and FIG. 10.

Assume input voltage has small ripple Vin and lamp resistance is r.

Output voltage of Error Amplifier is Va, output voltage is Vo;

open loop gain of the Error Amplifier is Aol, Gm is transconductance of the Field-Effect transistor (FET);

$$Va := Vo \cdot ( \frac{R 2}{R 1 + R 2} ) \cdot Aol$$

$$Vo := Gm \cdot Vgs \cdot r$$

$$Vgs := Vin - Va$$

From above equations, we get

$$Vo := \frac{Vin}{( \frac{R 2}{R 1 + R 2} ) \cdot Aol + \frac{1}{Gm \cdot r}}$$

$$R 1 \text{/} ( R 1 + R 2 ) = 0.1 , \\ Aol = 1000000 , Gm = 33 ms , r = 30$$

$$Vo = Vin \text{/} ( 100000 + 1 )$$

So if input has a ripple or noise Vin, output noise or ripple will be reduced to 1/100000. Input ripple typical value is 100 mv, so the ripple is reduced to 0.1V/100000= 1/1000000V. That is almost 0.

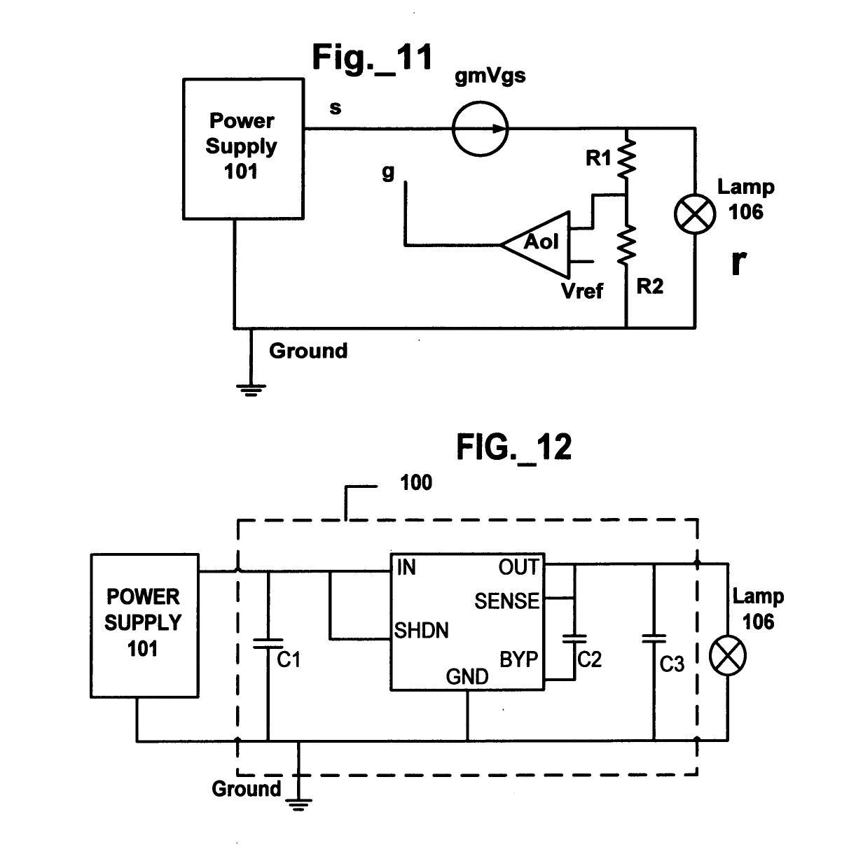

FIG. 12 is a schematic of a low drop out regulator integrated circuit used in the invention 100.

Pin SHDN and pin IN are connected to power supply 101 and one end of a capacitor C1. The other end of a capacitor C1 is connected to ground. Pin GND is connected to ground. Pin OUT and PIN sense are connected to output lamp 106, one end of a capacitor C2 and one end of a capacitor C3. Pin BYP is connected to the other end of a capacitor C2. The other end of a capacitor C3 is connected to ground.

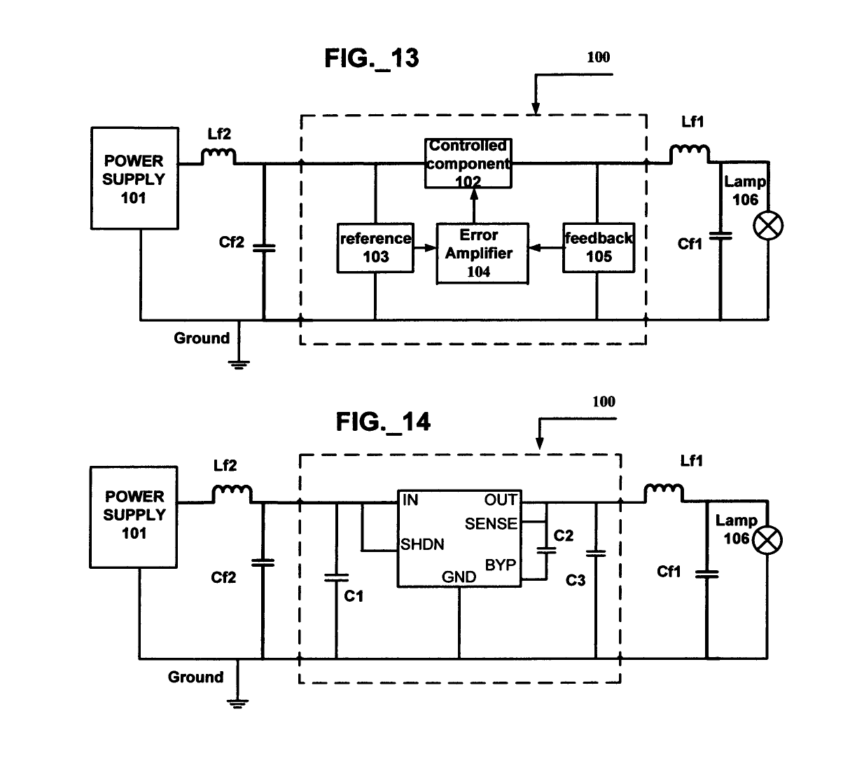

FIG. 13 is a block diagram of the invention with an input L-C filter and an output L-C filter. Power supply 101 is connected to one end of inductor Lf2, the other end of inductor Lf2 is connected to the input of invention 100 and one end of capacitor Cf2, the other end of capacitor Cf2 is grounded. The output of invention 100 is connected to one end of inductor Lf1. The other end of inductor Lf1 is connected to lamp 106 and one end of capacitor Cf1. The other end of capacitor Cf1 is grounded. The invention includes reference 103, Error Amplifier 104, feedback 105 and controlled component 102.

FIG. 14 is a schematic of a low drop out regulator integrated circuit used in the invention with an input L-C filter and an output L-C filter.

Power supply 101 is connected to one end of inductor Lf2, the other end of inductor Lf2 is connected to Pin SHDN and pin IN, one end of a capacitor Cf2, one end of a capacitor C1. The other end of capacitor Cf2 and the other end of a capacitor C1 are grounded. Pin GND is connected to ground. Pin OUT and Pin SENSE are connected to one end of inductor Lf1, one end of capacitor C2 and one end of capacitor C3. Pin BYP is connected to the other end of capacitor C2. The other end of capacitor C3 is connected to ground. The other end of inductor Lf1 is connected to lamp 106 and one end of capacitor Cf1. The other end of capacitor Cf1 is grounded.

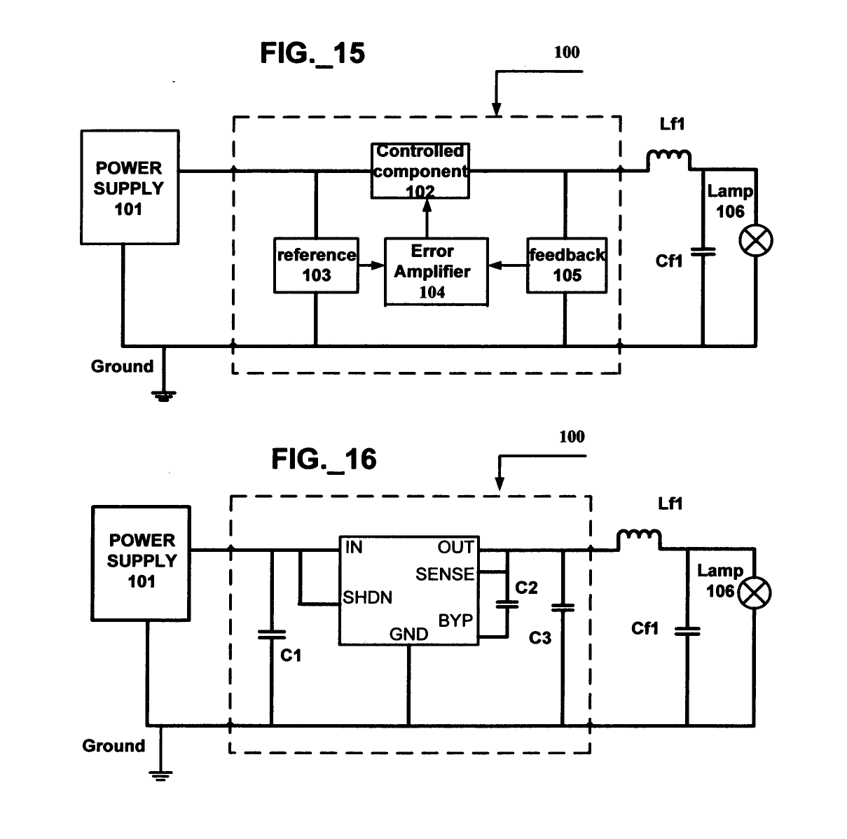

FIG. 15 is a block diagram of the invention with an output L-C filter.

Power supply 101 is connected to the input of invention 100, The output of invention 100 is connected to one end of inductor Lf1. The other end of inductor Lf1 is connected to lamp 106 and one end of capacitor Cf1. The other end of capacitor Cf1 is grounded.

The invention 100 includes reference 103, Error Amplifier 104, feedback 105 and controlled component 102.

FIG. 16 is a schematic of a low drop out regulator integrated circuit used in the invention with an output L-C filter.

Pin SHDN and Pin IN are connected to the power supply 101 and one end of a capacitor C1, the other end of a capacitor C1 is connected to ground. Pin GND is connected to ground. Pin OUT and Pin SENSE are connected to one end of output inductor Lf1, one end of a capacitor C2 and one end of a capacitor C3. Pin BYP is connected to the other end of a capacitor C2. The other end of output capacitor C3 is connected to ground. The other end of inductor Lf1 is connected to lamp 106 and one end of capacitor Cf1. The other end of capacitor Cf1 is connected to ground.

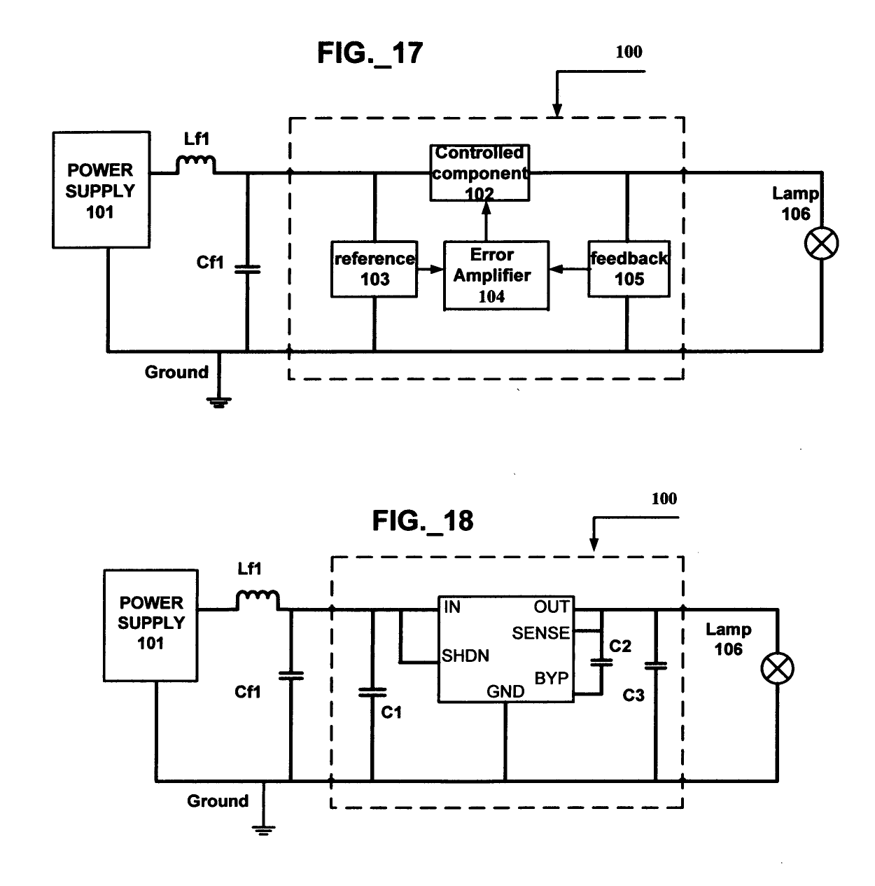

FIG. 17 is a block diagram of the invention 100 with an input L-C filter.

Power supply 101 is connected to one end of inductor Lf1, the other end of inductor Lf1 is connected to one end of capacitor Cf1 and the input of invention 100, the other end of capacitor Cf1 is grounded. The output of invention 100 is connected to lamp 106. The invention 100 includes reference 103, Error Amplifier 104, feedback 105 and a controlled component 102.

FIG. 18 is a schematic of a low dropout regulator integrated circuit used in the invention 100 with an input L-C filter.

Power supply 101 is connected to one end of inductor Lf1. The other end of inductor Lf1 is connected one end of a capacitor Cf1, one end of a capacitor C1, Pin SHDN and pin IN of integrated circuit. The other end of a capacitor C1 is connected to ground. Pin GND is connected to ground. Pin OUT and Pin SENSE are connected to lamp 106, one end of a capacitor C2 and one end of a capacitor C3. Pin BYP is connected to the other end of capacitor C2. The other end of capacitor C3 is connected to ground.

A number of implementations have been described. Nevertheless, it will be understood that various modifications may be made without departing from the spirit and scope of the invention.

The L-C filter between power supply and the input of the invention or the L-C filter between output of the invention and lamp can be replace by the filter as the following: L filter, T filter, π filter, R-C filter, low-pass filter, high-pass filter, band-pass filter, band-stop filter, all-pass filter, SAW filter, BAW filter, Garnet filter, all-pass filter, passive filter, active filter or the combination of the filters in series or in parallel.

What is claimed is:

1. A lamp filter comprising:
A reference operable to generate a reference voltage;
A feedback operable to generate a feedback signal proportional to output lamp voltage or current;
An error amplifier operable to generate a voltage proportional to error between feedback signal and reference; and
A controlled component operable to be controlled by output voltage from error amplifier to vary the current from input power supply to output lamp or the resistance in the controlled component between power supply and output lamp.

2. The lamp filter of claim 1, wherein the lamp filter is either discrete components or an integrated circuit.

3. The lamp filter of claim 1, wherein the lamp filter is a low dropout regulator.

4. The lamp filter of claim 1, wherein the lamp filter is low dropout regulators in series or in parallel.

5. The lamp filter of claim 1, wherein the lamp filter is a linear regulator.

6. The lamp filter of claim 1, wherein the lamp filter is linear regulators in series or in parallel.

7. The lamp filter of claim 1, wherein the output lamp is a LED lamp.

8. The lamp filter of claim 1, wherein the output lamp is LED lamps in series or in parallel.

9. The lamp filter of claim 1, wherein the output lamp is an OLED lamp.

10. The lamp filter of claim 1, wherein the output lamp is OLED lamps in series or in parallel.

11. The lamp filter of claim 1, wherein the output lamp is a LED lamp in series with a resistor, resistors or parallel with a resistor or resistors.

12. The lamp filter of claim 1, wherein the output lamp is an OLED lamp in series with a resistor, resistors or parallel with a resistor or resistors.

13. The lamp filter of claim 1, wherein the output lamp is LED lamps in series with a resistor, resistors or parallel with a resistor, resistors.

14. The lamp filter of claim 1, wherein the output lamp is OLED lamps in series with a resistor, resistors or parallel with a resistor, resistors.

15. The lamp filter of claim 1, wherein the controlled component is a NPN bipolar junction transistor, a PNP bipolar junction transistor, a N-Channel Field-Effect transistor or a P-Channel Field-Effect transistor.

16. The lamp filter of claim 1, wherein the controlled component is NPN bipolar junction transistors, PNP bipolar junction transistors, N-Channel Field-Effect transistors or P-Channel Field-Effect transistors in series or in parallel.

17. The lamp filter of claim 1, wherein the controlled component is a Gallium arsenide field effect transistor, a Darlington transistor, an insulated-gate bipolar transistor, silicon-controlled rectifier, a Thyristor, a TRIAC or an unijunction transistor.

18. The lamp filter of claim 1, wherein the controlled component is a Gallium arsenide field effect transistors, Darlington transistors, insulated-gate bipolar transistors, silicon-controlled rectifiers, Thyristors, TRIACs or unijunction transistors in series or in parallel.

19. The lamp filter of claim 1, wherein the output lamp is an incandescent lamp.

20. The lamp filter of claim 1, wherein the output lamp is a fluorescent lamp.
